(19) United States
(12) Patent Application Publication
(10) Pub. No.: US 2026/0351498 A1
(43) Pub. Date: Nov. 5, 2026

(54) VACUUM INTERRUPTER, VACUUM SWITCH AND PARALLEL LOAD-BREAK SWITCH

(71) Applicant: EATON ELECTRICAL LTD., Suzhou (CN)

(72) Inventors: Martin Bernardus Johannes LEUSENKAMP, Suzhou (CN); Jun YAN, Suzhou (CN); Yucheng LI, Suzhou (CN)

(21) Appl. No.: 19/639,296

(22) Filed: Apr. 5, 2026

(30) Foreign Application Priority Data
Apr. 30, 2025 (CN) 202520851310.8

(51) Int. Cl. H01H 33/662; H01H 33/664

(52) U.S. Cl. CPC H01H 33/66207; H01H 33/664

(57) ABSTRACT

Some embodiments include a vacuum interrupter including an insulating housing, a movable and a stationary contact assemblies respectively passing through opposite end portions of the housing. The inner wall of the housing has a first and second variable-diameter portions dividing the housing into a first area in the middle, second area adjacent to the stationary contact assembly, and third area adjacent to the movable contact assembly. A movable contact of the movable contact assembly and a stationary contact of the stationary contact assembly are disposed in a space defined by the first area. The first variable-diameter portion is a first protrusion protruding relative to inner walls of the first and second areas and the second variable-diameter portion is a second protrusion protruding relative to an inner wall of the third area, so that metal vapor generated by separating contacts is limited in the space defined by the first area.

### CROSS REFERENCE TO RELATED APPLICATIONS

The present application claims benefit from Chinese Patent Application No. 202520851310.8, filed on Apr. 30, 2025, and is incorporated hereby by reference in its entirety.

### TECHNICAL FIELD

The present disclosure pertains to the field of switches, and in particular, relates to a vacuum interrupter, a vacuum switch, and a parallel load switch.

### BACKGROUND

The statements in this part are merely intended to provide background information related to the present disclosure, to help understand the present disclosure. The background information does not necessarily constitute the prior art.

A vacuum switch is a switch device that uses vacuum as an arc-extinguishing and insulating medium. As a core component of the vacuum switch, a vacuum interrupter is used to quickly extinguish an electric arc during opening of a circuit, thereby preventing a device from being damaged by arc restrike or sustained discharge. Due to the widespread application of the vacuum interrupter in medium- and high-voltage switch devices, persons skilled in the art have been continuously striving to improve related performance of the vacuum interrupter.

### SUMMARY

Therefore, an objective of the present disclosure is to overcome the foregoing defect in the prior art, and provides a vacuum interrupter. The vacuum interrupter includes: an insulating housing, a movable contact assembly, and a stationary contact assembly, where the movable contact assembly and the stationary contact assembly respectively pass through opposite end portions of the insulating housing, an inner wall of the insulating housing has a first variable-diameter portion and a second variable-diameter portion, the first variable-diameter portion and the second variable-diameter portion divide the insulating housing into a first area in the middle, a second area adjacent to the stationary contact assembly, and a third area adjacent to the movable contact assembly, the movable contact assembly includes a movable contact, the stationary contact assembly includes a stationary contact, and the movable contact and the stationary contact are disposed in a space defined by the first area, where the first variable-diameter portion is a first protrusion that protrudes relative to an inner wall of the first area and an inner wall of the second area, and the second variable-diameter portion is a second protrusion that protrudes relative to an inner wall of the third area, so that metal vapor generated by separation of the movable contact and the stationary contact can be limited in the space defined by the first area. The vacuum interrupter is particularly applicable to a parallel load switch.

According to the vacuum interrupter of the present disclosure, preferably, a transverse limited dimension of the first area is less than a transverse limited dimension of the third area, and the second protrusion is a step portion at a boundary of the first area and the third area.

According to the vacuum interrupter of the present disclosure, preferably, outer surfaces of the first area, the second area, and the third area are flush with each other, the first area has a first thickness, and the third area has a thickness less than the first thickness.

According to the vacuum interrupter of the present disclosure, preferably, the second area has a thickness less than the first thickness.

According to the vacuum interrupter of the present disclosure, preferably, the outer surfaces of the first area, the second area, and the third area further have a corrugated structure.

According to the vacuum interrupter of the present disclosure, preferably, the movable contact and the stationary contact each include a first portion and a second portion protruding from the first portion, a transverse dimension of the first portion being greater than a transverse dimension of the second portion.

According to the vacuum interrupter of the present disclosure, preferably, the movable contact assembly further includes a movable conductive rod, the stationary contact assembly further includes a stationary conductive rod, the movable conductive rod and the movable contact each have a matching mechanical connection portion, and the stationary conductive rod and the stationary contact each have a matching mechanical connection portion.

According to the vacuum interrupter of the present disclosure, preferably, at least one of the movable conductive rod and the stationary conductive rod is a stainless steel conductive rod.

According to another aspect, the present disclosure further provides a vacuum switch. The vacuum switch includes the foregoing vacuum interrupter according to the present disclosure.

According to still another aspect, the present disclosure further provides a parallel load switch. The parallel load switch includes the vacuum switch according to the present disclosure and a rotary switch, where the rotary switch includes a first wiring terminal, a second wiring terminal, a rotary driving conductive rod, and an arc-shaped contact, the rotary driving conductive rod being configured such that one end thereof is electrically connected to the arc-shaped contact and to enable the arc-shaped contact to move along an arc, and the first wiring terminal and the second wiring terminal being arranged on the arc, where a first outgoing terminal of the vacuum switch is electrically connected to the first wiring terminal, a second outgoing terminal of the vacuum switch is electrically connected to a first terminal of the parallel load switch, the second wiring terminal is electrically connected to a second terminal of the parallel load switch, and the other end of the rotary driving conductive rod is electrically connected to a third terminal of the parallel load switch.

Compared with the prior art, the vacuum interrupter design according to the present disclosure does not have a metal shield, which significantly reduces the dimension of the interrupter, and improves insulation performance in a miniaturized insulating housing. The interior of a ceramic housing features in a two-step shape, thereby eliminating a metal shield. Typically, such a structure is not applicable in a standard interrupter because a large amount of vapor is generated during current interruption, and the vapor deposits on the ceramic housing and then affects the insulation performance of the entire vacuum interrupter. However, actually, in a vacuum interrupter that is used for a small load switch, an interrupting current is low, and only a limited number of electrical operations need to be performed. Therefore, such a structure is feasible. A specially-designed contact shape also helps prevent metal vapor from depositing in all areas of an inner surface of a ceramic housing and damaging insulation performance of the ceramic housing. In addition, to minimize contamination of the inner surface of the ceramic housing by the metal vapor, a specially shaped contact with steps is designed to control a diffusion direction of the metal vapor.

### BRIEF DESCRIPTION OF DRAWINGS

The following further describes embodiments of the present disclosure with reference to the accompanying drawings, where:

FIG. 1 is a schematic structural diagram of a longitudinal section of a vacuum interrupter according to an embodiment of the present disclosure;

FIG. 2 is a perspective view of a vacuum interrupter according to an embodiment of the present disclosure;

FIG. 3 is an enlarged view of a portion of FIG. 2;

FIG. 4 is a schematic structural diagram of a parallel load switch according to an embodiment of the present disclosure; and

FIG. 5 is a schematic diagram of a breaking process of a parallel load switch according to an embodiment of the present disclosure.

### DETAILED DESCRIPTION

To make the objectives, technical solutions, and advantages of the present disclosure clearer, the following further describes the present disclosure in detail through specific embodiments with reference to the accompanying drawings. It should be understood that the specific embodiments described herein are merely used to explain the present disclosure, and are not intended to limit the present disclosure.

The inventor found that at present, the mainstream research and development direction of a vacuum interrupter focuses on improving its breaking capability to a high current (e.g., 630 A to 6300 A) to meet a short-circuit fault protection requirement of a power system. Under the guidance of this technology, a person skilled in the art mainly focuses on improving electrical performance (e.g., insulation strength, breaking capability, current-carrying capability, etc.) of the vacuum interrupter, which results in higher costs and a larger volume of the vacuum interrupter.

One of core design criteria for electrodes (conductive rods) of the vacuum interrupter is low contact resistance. Currently, a person skilled in the switch field agrees that copper-based materials (pure copper or copper alloy) are ideal choices for the electrodes, because a copper matrix can ensure low contact resistance and reduce temperature rise.

Stainless steel is a corrosion-resistant alloy steel with iron (Fe) as a matrix into which alloying elements such as chromium (Cr≥10.5%), nickel (Ni), molybdenum (Mo), and nitrogen (N) are added. Stainless steel has excellent corrosion resistance and mechanical strength. However, the electrical conductivity of stainless steel is significantly lower than that of metal materials such as copper (the resistivity is about 40 times that of pure copper), the resistance to electric arc erosion is relatively weak, and softening or intergranular corrosion is prone to happen in a high-temperature environment. For a long time, stainless steel has not become a mainstream choice in the field of conductive materials, and the technical advantages of stainless steel have focused more on structural functions rather than electrical performance. In particular, due to poor electrical conductivity of stainless steel, a person skilled in the art has never thought of fabricating electrodes of a vacuum interrupter by using a stainless steel material.

The inventor of the present disclosure has overcome technical prejudices and creatively proposes a vacuum interrupter with stainless steel electrodes. Such a vacuum interrupter is connected in parallel to a main circuit in application and thus is also referred to as a shunt vacuum interrupter. In most usage scenarios (including when the main circuit is operating normally and when the main circuit is opened), the vacuum interrupter is in a non-current-carrying state, and conducts current briefly only during an opening process of the main circuit. The inventor recognizes that because of short-duration current conduction, large resistance of the stainless steel electrodes does not cause a relatively large temperature rise. On the other hand, because of high mechanical strength of the stainless steel material, a small-dimension electrode can meet an electrode strength requirement, so that the volume of the vacuum interrupter can be significantly reduced, and the cost of the vacuum interrupter is also significantly reduced.

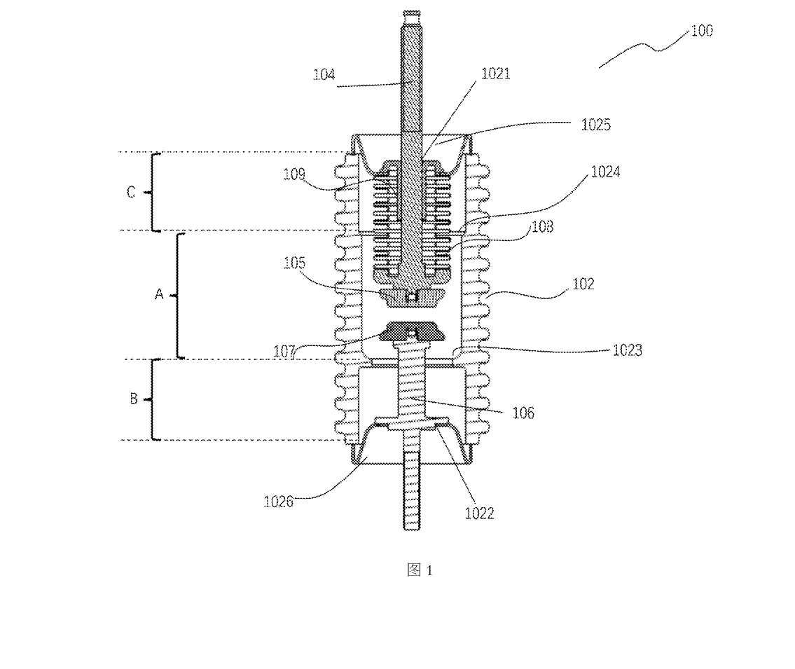

According to some embodiments of the present disclosure, a vacuum interrupter is provided. FIG. 1 is a schematic structural diagram of a longitudinal section of the vacuum interrupter 100 according to an embodiment. The vacuum interrupter according to the embodiment includes an insulating housing 102 as well as a movable contact assembly and a stationary contact assembly that pass through opposite end portions of the insulating housing 102, respectively. The movable contact assembly includes a movable conductive rod 104 that passes through a first end portion (e.g., a first through hole 1021 thereof) of the insulating housing 102 and a movable contact 105 that is disposed at one end portion of the movable conductive rod 104. The stationary contact assembly includes a stationary conductive rod 106 that passes through a second end portion (e.g., a second through hole 1022 thereof) of the insulating housing 102 opposite to the first end portion and a stationary contact 107 that is disposed at one end portion of the stationary conductive rod 106. A circuit is closed and opened by engaging and separating the movable contact 105 and the stationary contact 107. In the embodiments of the present disclosure, at least one of the movable conductive rod 104 and the stationary conductive rod 106 is a stainless steel conductive rod, in particular, a cold-stamped stainless steel conductive rod. The stainless steel conductive rod has a higher mechanical strength, so that the stainless steel conductive rod can be adapted to a smaller dimension. The diameter of the stainless steel conductive rod of the present disclosure is about one third of the diameter of a conventional copper conductive rod. In the embodiments of the present disclosure, the diameter of the stainless steel conductive rod does not exceed 15 mm.

Further, to achieve dynamic sealing of the vacuum interrupter, that is, to maintain vacuum seal of the interrupter during movement of the movable contact, the movable contact assembly further includes a tubular elastic element sleeved outside the movable conductive rod 104, as shown in FIG. 1. The tubular elastic element is preferably a bellows 108. The bellows is a metal tube having a corrugated shape, usually made of a stainless steel material. Preferably, one end of the bellows 108 is fastened to the insulating housing 102 by means of welding or mechanical connection and is in close contact with the first through hole 1021, and the other end is fastened to the movable conductive rod 104. A corrugated structure of the bellows enables the bellows to elastically expand and compress in an axial direction, thereby allowing the movable conductive rod 104 to move freely within a certain range and meeting operation requirements of the interrupter. The bellows 108 can correspondingly expand and compress when the movable conductive rod 104 moves, but the corrugated structure of the bellows enables the bellows to maintain seal.

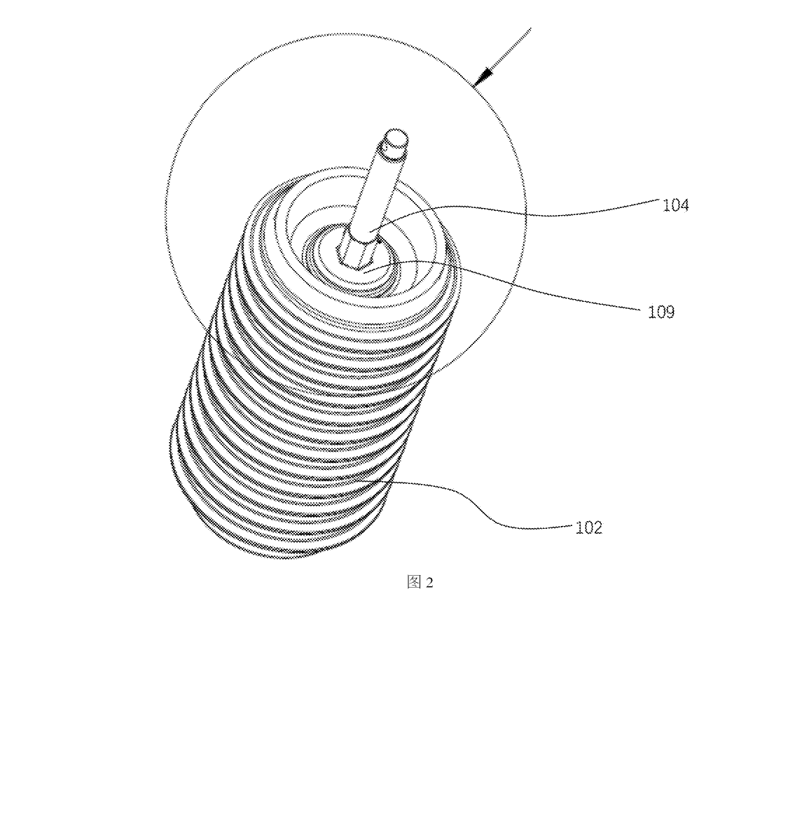

In another embodiment, preferably, as shown in FIG. 1 and FIG. 2, FIG. 2 is a perspective view of a vacuum interrupter according to an embodiment of the present disclosure. The movable contact assembly further includes a sleeve 109 disposed between the movable conductive rod 104 and the bellows 108. The sleeve 109 is shaped to match the movable conductive rod 104 and plays a “mechanical buffer” role between the movable conductive rod 104 and the bellows 108. Specifically, during movement, the movable conductive rod may rub against an inner wall of the bellows, and the sleeve can reduce such direct contact, thereby reducing wear on the bellows and prolonging the service life of the bellows. In particular, in a case of burrs or unevenness on the surface of the movable conductive rod, the sleeve can prevent the movable conductive rod from scratching the inner wall of the bellows during movement. The sleeve may further provide additional support for the movable conductive rod, to reduce shaking and vibration of the movable conductive rod during movement, thereby improving mechanical stability of the system. The sleeve can ensure concentricity between the movable conductive rod and the bellows, thereby reducing stress concentration caused by eccentric movement, and further improving reliability of the system. In short, the sleeve can improve the operation reliability of the interrupter by means of mechanisms such as motion guidance, wear isolation, and stress dispersion, which is one of the key technologies for a long-life design of a vacuum switch device.

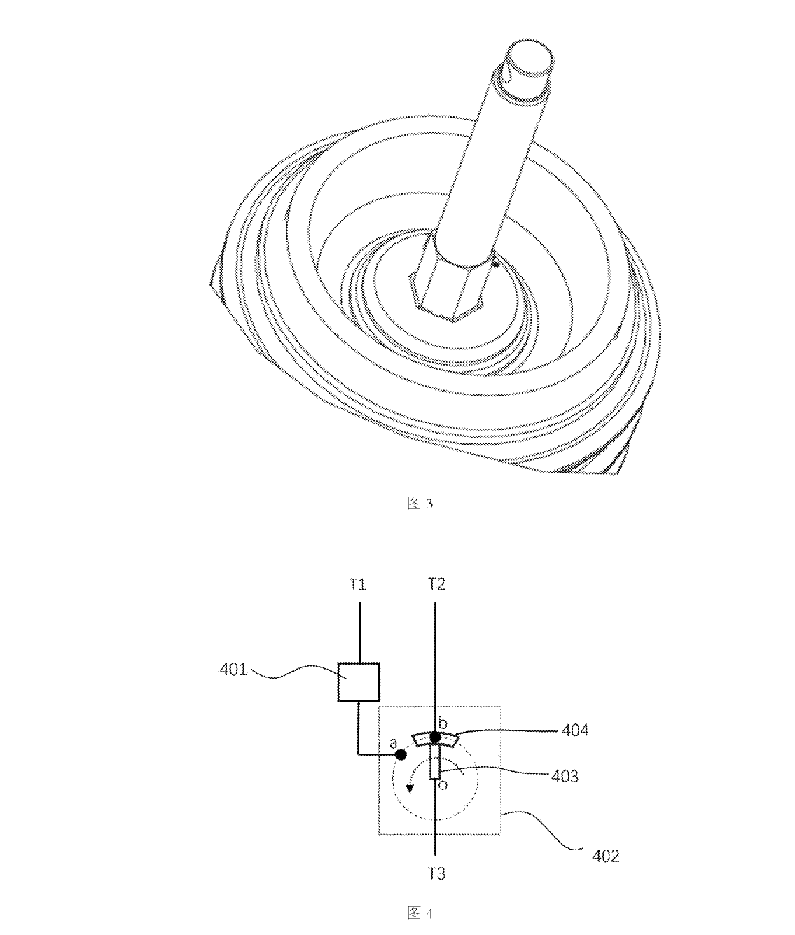

In an embodiment of the present disclosure, preferably, referring to FIG. 2 and an enlarged view of a circle area of FIG. 2 shown in FIG. 3, a portion of the movable conductive rod 104 in contact with the sleeve 109 is hexagonal prism-shaped, and correspondingly, the sleeve 109 is also hexagonal prism-shaped. Edges of a hexagonal prism can naturally form a positioning portion and a limiting portion, facilitating the matching connection and fixation between the movable conductive rod 104 and the sleeve 109. In addition, a portion of the movable conductive rod 104 not in contact with the sleeve 109 may be formed into any desired shape. For example, to implement connection with an external component of the interrupter, a corresponding portion of the movable conductive rod 104 may be formed with a threaded shape. A person skilled in the art can understand that a portion of the movable conductive rod 104 in contact with the sleeve 109 is not limited to a hexagonal prism shape, and any shape that has an edge can implement positioning and limiting between the movable conductive rod and the sleeve 109, for example, a triangular prism shape, a quadrangular prism shape, a pentagonal prism shape, a heptagonal prism shape, an octagonal prism shape, and so on.

In an embodiment of the present disclosure, preferably, the insulating housing 102 is a ceramic housing, preferably a preformed ceramic housing. As shown in FIG. 1 and FIG. 2, an outer wall of the insulating housing 102 has a corrugated surface. However, in an embodiment of the present disclosure, the shape of the outer wall of the ceramic housing is not limited, and the outer wall may have a surface of any other shape, including a planar surface.

For a vacuum interrupter, when an electric arc is extinguished within the interrupter, a contact material (e.g., copper or alloy thereof) evaporates due to a high temperature, forming metal vapor. The metal vapor may deposit on the inner wall of the insulating housing of the interrupter, resulting in reduction of insulation performance of the insulating housing. The inventor further found that, currently, in order to overcome impact of the metal vapor on the insulation performance of the insulating housing, a metal shield is typically used to absorb the metal vapor to form a condensate shell, preventing the metal vapor from contaminating the surface of the insulating housing and thereby maintaining the insulation performance of the insulating housing.

The inventor also creatively uses an unshielded design in which the metal vapor is limited by specially designing the inner wall of an insulating housing, thereby reducing the impact of the metal vapor on the insulating housing.

In some embodiments of the present disclosure, as shown in FIG. 1, the inner wall of the insulating housing 102 has a first variable-diameter portion 1023 and a second variable-diameter portion 1024, the movable contact 105 and the stationary contact 107 are disposed in an area between the first variable-diameter portion 1023 and the second variable-diameter portion 1024, and a movement range of the movable contact 105 is also within this area. The first variable-diameter portion 1023 and the second variable-diameter portion 1024 divide the insulating housing 102 into a first area A that accommodates the movable contact 105 and the stationary contact 107, a second area B that accommodates at least a portion of the stationary conductive rod 106, and a third area C that accommodates at least a portion of the movable conductive rod 104, the bellows 108, and the sleeve 109. In some embodiments, the first, second, and third areas have an identical thickness. In some other embodiments, outer surfaces of the three areas of the insulating housing 102 are flush with each other, the first area A and the second area B have an identical thickness d1, and the third area C has a thickness d2 less than the thickness d1, so that a larger internal space is provided in the third area than in the other two areas. In some other embodiments, the outer surfaces of the three areas of the insulating housing 102 are flush with each other, and the thicknesses of the second area B and the third area C are both less than the thickness of the first area A. Optionally, a protruding corrugated structure for increasing an external insulation distance is further disposed on an outer surface of the insulating housing 102. In some embodiments, the thickness d2 is 80% to 95% of the thickness d1. Compared with a design in the prior art in which a wall thickness of a middle area is only half of a wall thickness of two side areas, in this embodiment, an electric arc resisting capability and thermal stability of a contact area are significantly improved by optimizing wall thickness distribution, and material waste is avoided and more sufficient space is created for installation of internal complex components by appropriately reducing a wall thickness of a non-key area, thereby achieving balanced optimization of reliability, compactness, and cost effectiveness.

When the movable contact 105 and the stationary contact 107 separate, an electric arc will be generated. When the electric arc is extinguished in the interrupter, the metal vapor formed by the contact material may deposit on the inner wall of the insulating housing 102 of the interrupter, thereby resulting in reduction of insulation performance of the insulating housing 102. The first variable-diameter portion 1023 and the second variable-diameter portion 1024 of the present disclosure can prevent the metal vapor from diffusing into an outer area, that is, limit the metal vapor in an area between the first variable-diameter portion 1023 and the second variable-diameter portion 1024 without affecting other areas. In this way, only a small portion of the ceramic housing 102 is deposited with metal vapor, which does not significantly affect overall insulation performance of the ceramic housing. Based on the ingenious design of the present disclosure, a special shield may be omitted, a manufacturing process is simplified, and the cost is saved.

In a preferred embodiment of the present disclosure, the first variable-diameter portion 1023 is a first protrusion that protrudes relative to an inner wall of the first area A and an inner wall of the second area B. The larger the dimension of the first protrusion, the better the effect of blocking the metal vapor from entering the second area B. However, considering smooth insertion of the stationary contact during assembly of the vacuum interrupter, an internal area defined by the first protrusion should at least allow the stationary contact to pass through. Preferably, the first protrusion is an annular protrusion, and the inner diameter of the annular protrusion needs to be at least greater than the outer diameter of the stationary contact. In some embodiments, the second variable-diameter portion is a second protrusion that protrudes relative to an inner wall of the third area C. In some embodiments, the second variable-diameter portion is a second protrusion that protrudes relative to both the inner wall of the first area A and the inner wall of the third area C. The larger the dimension of the second protrusion, the better the effect of blocking the metal vapor from entering the third area C. Similarly, considering smooth insertion of the movable contact during assembly of the vacuum interrupter, an internal area defined by the second protrusion should at least allow the movable contact to pass through. Preferably, the second protrusion is also an annular protrusion, and the inner diameter of the annular protrusion needs to be at least greater than the outer diameter of the movable contact.

In some embodiments of the present disclosure, as shown in FIG. 1, the second variable-diameter portion 1024 is close to the bellows 108. A transverse dimension of the bellows 108 is far greater than that of the movable conductive rod 104 and increases during a compression process of the bellows 108. Therefore, when the second variable-diameter portion 1024 is formed as the second protrusion, considering that the second protrusion does not affect expansion and compression of the bellows 108, an inner edge of the second protrusion must be a certain distance away from an outer edge of the bellows. This needs to increase the transverse dimension of the insulating housing, which also increases the volume of the vacuum interrupter, and is not conducive to miniaturization of the vacuum interrupter.

The inventor further found that the metal vapor generated by the separation of the movable and stationary contacts basically moves in a straight line. When the metal vapor encounters a nearest inner wall area of an insulating housing, most of the metal vapor condenses in this area, and a small portion moves in a straight line along the inner wall (for example, moves upward or downward in FIG. 1) due to the obstruction of the inner wall in this area. The inventor creatively conceived of configuring the second variable-diameter portion 1024 as a step portion (as shown in FIG. 1). The step portion is formed by an internal diameter difference between the first area A and the third area C of the insulating housing on both sides of the step portion. As shown in FIG. 1, the first protrusion 1023 is arranged at a boundary of the first area A and the second area B. A transverse limited dimension of the first area A (meaning a cross-sectional dimension of an internal space of the vacuum interrupter defined by the first area A, preferably a cross-sectional diameter of the internal space) is less than a transverse limited dimension of the third area C (meaning a cross-sectional dimension of an internal space of the vacuum interrupter defined by the third area C, preferably a cross-sectional diameter of the internal space), thereby forming a step portion at a boundary of the first area A and the third area C. The transverse limited dimension of the first area A is less than the transverse limited dimension of the third area C, and the inner wall of the third area C is located laterally outside the inner wall of the first area A. Therefore, when the metal vapor moves along the first area A toward the third area C due to the obstruction of the first area A, the metal vapor moving in a straight line cannot reach the third area C, and thus cannot condense in the third area C. Further preferably, the transverse limited dimension of the first area A is also smaller than a transverse limited dimension of the second area B, thereby further reducing a possible risk of the metal vapor bypassing the first protrusion 1023 and condensing in the second area B. In a preferred embodiment, the transverse limited dimension of the first area A is at least 5%, preferably 5% to 20%, smaller than the transverse limited dimensions of the second area B and the third area C.

In a further preferred embodiment, as shown in FIG. 1, the shapes of the movable contact 105 and the stationary contact 107 are specifically designed as step shapes, each including a first portion connected to a corresponding conductive rod and a second portion protruding from the first portion. A transverse dimension of the first portion is greater than that of the second portion, thereby forming a step portion between the first portion and the second portion. Preferably, the first portion and the second portion have arc-shaped chamfers. Preferably, the transverse dimension of the first portion is at least 10%, preferably 10% to 20%, greater than the transverse dimension of the second portion. When the movable contact 105 and the stationary contact 107 separate, an electric arc is formed between a second portion of the movable contact and a second portion of the stationary contact, and the generated metal vapor is blocked and guided by the step portion, thereby further reducing the metal vapor reaching the inner wall of the second area and the inner wall of the third area. In another embodiment of the present disclosure, only one of the movable contact and the stationary contact is designed as a step shape.

In a further preferred embodiment of the present disclosure, a dual-connection manner of mechanical connection and metallurgical connection is used for connection between a contact and a conductive rod. The mechanical connection includes bolt, rivet, clip, and key connections, and the like. The metallurgical connection is also referred to as material connection, and includes various welding processes such as fusion welding, pressure welding, braze welding, and the like. Currently, a contact and a conductive rod are generally connected together by means of welding only. Therefore, a preparation process of a vacuum interrupter includes two welding procedures: one is welding of the contact and the conductive rod, and the other is welding of all components of the vacuum interrupter including a contact assembly. In a preparation process of the vacuum interrupter of the present disclosure, first, the contacts and the conductive rods are mechanically connected together to form a contact pre-assembly; then the contact pre-assembly is installed in the housing, and then a single welding procedure is performed uniformly. This welding step can not only implement welding between the contacts and the conductive rods, but also implement welding among components of the vacuum interrupter. In summary, the contacts and the conductive rods of the vacuum interrupter of the present disclosure each have a matching mechanical connection portion, and welding steps of the manufacturing process of the vacuum interrupter can be saved by means of mechanical connection of the mechanical connection portion, thereby reducing manufacturing costs.

In the example shown in FIG. 1, the movable contact 105 and the movable conductive rod 104 are each provided with a matching riveting portion, and the stationary contact 107 and the stationary conductive rod 106 are each provided with a matching riveting portion. When the movable/stationary contact and the movable/stationary conductive rod are riveted by using the riveting portions, solder is inserted in advance into a contact area between the contact and the conductive rod. Then, the movable/stationary contact assembly is installed to the insulating housing 102 to perform a subsequent overall braze welding operation step.

In an embodiment of the present disclosure, the insulating housing 102 is an integrally formed ceramic housing with a simple structure and without a risk of end cover leakage. In another embodiment, the insulating housing 102 includes a first end cover 1025 and a second end cover 1026 that are disposed opposite to each other. The first through hole 1021 is disposed in the first end cover 1025, and the second through hole 1022 is disposed in the second end cover 1026. The end cover design improves sealing reliability and insulation safety of the insulating housing 102.

An embodiment of the present disclosure further provides a vacuum switch. The vacuum switch includes the foregoing vacuum interrupter according to the present disclosure, and further includes a first outgoing terminal and a second outgoing terminal that are respectively connected to the movable conductive rod and the stationary conductive rod of the vacuum interrupter, and an operation mechanism, for example, an insulating pull rod, for driving the movable conductive rod. The vacuum interrupter of the present disclosure is applicable to any vacuum switch known in the art. A specific structure of the vacuum switch is not described herein in detail.

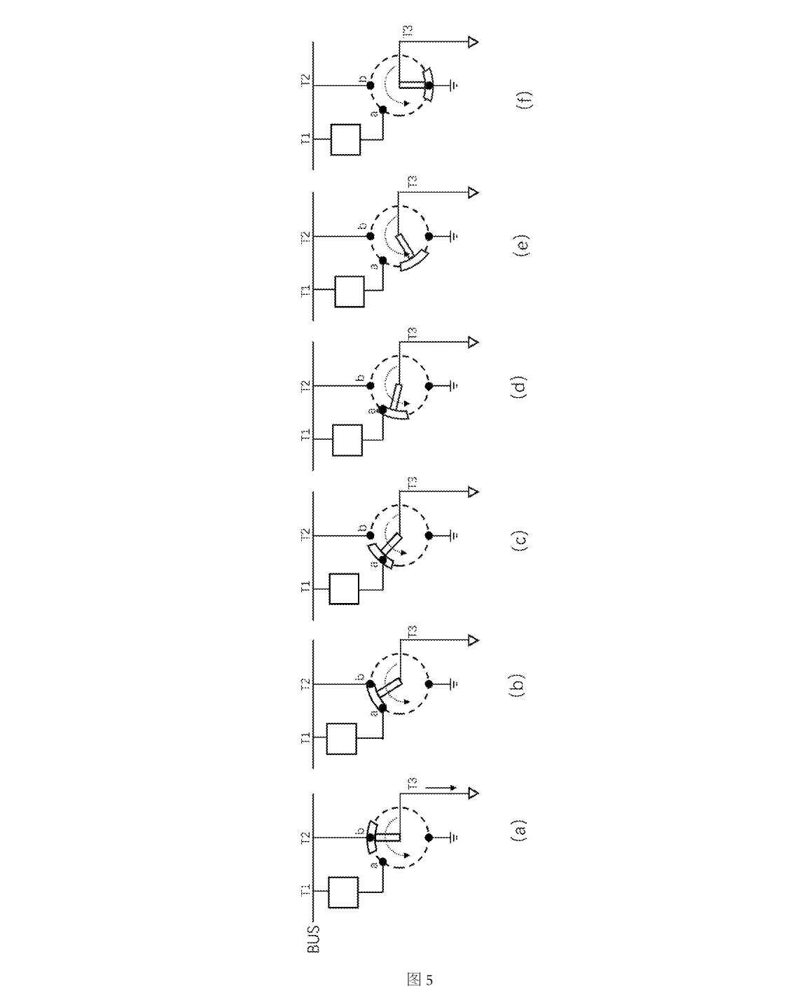

An embodiment of the present disclosure further provides a parallel load switch. Referring to a schematic structural diagram of the parallel load switch in this embodiment shown in FIG. 4, the parallel load switch includes the vacuum switch 401 according to the foregoing embodiment and a rotary switch 402, where the rotary switch 402 includes a first wiring terminal a, a second wiring terminal b, a rotary driving conductive rod 403, and an arc-shaped contact 404 fastened to one end of the rotary driving conductive rod 403, where the rotary driving conductive rod 403 can rotate around a rotation center o, so that the arc-shaped contact 404 moves along an arc with the rotation center o as a center. The first wiring terminal a and the second wiring terminal b are disposed on the arc. The rotation center o (that is, the other end of the rotary driving conductive rod 403) may further be used as a third wiring terminal of the rotary switch 402. The first outgoing terminal of the vacuum switch 401 is electrically connected to the first wiring terminal a of the rotary switch 402, and the second outgoing terminal of the vacuum switch 401 is used as (or is electrically connected to) a first terminal T1 of a parallel load switch. The second wiring terminal b of the rotary switch 402 is used as (or is electrically connected to) a second terminal T2 of the parallel load switch. The third wiring terminal of the rotary switch 402 is used as (or is electrically connected to) a third terminal T3 of the parallel load switch. With reference to a schematic diagram of a breaking process of a parallel load switch according to an embodiment of the present disclosure shown in FIG. 5, where BUS represents a main circuit bus. When the rotary driving conductive rod 403 drives the arc-shaped contact 404 to move along the arc, the following ON/OFF mode can be implemented:
when the arc-shaped contact 404 is electrically isolated from the first wiring terminal a and is electrically connected to the second wiring terminal b, a circuit between the second terminal T2 and the third terminal T3 is closed, and a circuit between the first terminal T1 and the third terminal T3 is opened (corresponding to a state shown in (a) in FIG. 5);
when the arc-shaped contact 404 is electrically connected to both the first wiring terminal a and the second wiring terminal b, the first terminal T1 and the second terminal T2 are electrically connected in parallel to the third terminal T3 (corresponding to a state shown in (b) in FIG. 5);
when the arc-shaped contact 404 is electrically connected to the first wiring terminal a and is electrically isolated from the second wiring terminal b, the circuit between the first terminal T1 and the third terminal T3 is closed, and the circuit between the second terminal T2 and the third terminal T3 is opened (corresponding to states shown in (c) and (d) in FIG. 5); and
when the arc-shaped contact 404 is electrically isolated from both the first wiring terminal a and the second wiring terminal b, both the circuit between the first terminal T1 and the third terminal T3 and the circuit between the second terminal T2 and the third terminal T3 are opened (corresponding to states shown in (e) and (f) in FIG. 5).

As shown in FIG. 5, in use of the parallel load switch, the first terminal T1, the second terminal T2, and the third terminal T3 are all connected in the main circuit. In a normal case, as shown in (a) in FIG. 5, an open state is maintained between the first terminal T1 and the third terminal T3, and a closed state is maintained between the second terminal T2 and the third terminal T3. After the parallel load switch receives a breaking instruction, the rotary driving conductive rod 403 rotates counterclockwise, driving the arc-shaped contact 404 to move counterclockwise along the arc. As shown in (b) in FIG. 5, the arc-shaped contact 404 is electrically connected to both the first wiring terminal a and the second wiring terminal b, and a main circuit current is shunted by a vacuum switch branch circuit. Next, the arc-shaped contact 404 continues to move and is electrically isolated from the second wiring terminal b. The main circuit current flows from the first terminal T1 to the third terminal T3 through the vacuum switch branch circuit, as shown in (c) and (d) in FIG. 5. In the phase from (c) in FIG. 5 to (d) in FIG. 5, the vacuum switch 401 implements separation of the movable contact and the stationary contact, and the vacuum switch branch circuit is opened, thereby implementing opening of the main circuit. Next, the rotary driving conductive rod 403 continues to rotate. As shown in (e) in FIG. 5, the arc-shaped contact 404 floats. In this case, the movable and stationary contacts of the vacuum switch 401 may engage and separate. As shown in (f) in FIG. 5, the arc-shaped contact 404 is electrically connected to a ground terminal, a main circuit load is grounded, and the entire breaking process of the parallel load switch is completed.

It may be learned that in the breaking process of the parallel load switch, the vacuum interrupter has a current passing through it only in a process from (b) to (d) in FIG. 5, and a current passing time is very short. Typically, the current passing time of the vacuum interrupter is less than 100 milliseconds, and the breaking time is dozens of milliseconds. In addition, in a current passing process, the vacuum interrupter just shunts rather than fully carries the main circuit current for a period of time. Therefore, a load current of the vacuum interrupter is also relatively small. The foregoing shunt vacuum interrupter of the present disclosure is particularly applicable to an application scenario with such a small load current and a short current passing time, because such a small load current and a short current passing time will not cause an excessive temperature rise of a stainless steel conductive rod.

A making process of the parallel load switch in this embodiment is opposite to the foregoing breaking process. The rotary driving conductive rod 403 drives the arc-shaped contact 404 to rotate clockwise from a grounded state, and finally reach a state of being electrically connected to only the second wiring terminal b. Details are not described herein again.

The vacuum interrupter of the present disclosure uses stainless steel conductive rods, and can reduce the diameter of the conductive rods to less than 15 mm, so as to reduce the diameter of the insulating housing of the vacuum interrupter to less than 80 mm, thereby implementing a compact vacuum interrupter. The vacuum interrupter of the present disclosure further omits a special shield, thereby reducing costs. In addition, the contacts and the conductive rods of the vacuum interrupter of the present disclosure are connected in a dual-connection manner of mechanical connection and metallurgical connection, thereby reducing process complexity and cost.

The parallel load switch of the present disclosure uses the vacuum interrupter of the present disclosure, and has a small volume, a low cost, and a simple manufacturing process.

Although the present disclosure has been described by using preferred embodiments, the present disclosure is not limited to the embodiments described herein, and includes various changes and variations without departing from the scope of the present disclosure.

What is claimed is:

1. A vacuum interrupter, comprising:
an insulating housing,
a movable contact assembly, and
a stationary contact assembly, wherein
the movable contact assembly and the stationary contact assembly respectively pass through opposite end portions of the insulating housing, an inner wall of the insulating housing has a first variable-diameter portion and a second variable-diameter portion, the first variable-diameter portion and the second variable-diameter portion divide the insulating housing into a first area in the middle, a second area adjacent to the stationary contact assembly, and a third area adjacent to the movable contact assembly, the movable contact assembly comprises a movable contact, the stationary contact assembly comprises a stationary contact, and the movable contact and the stationary contact are disposed in a space defined by the first area, wherein
the first variable-diameter portion is a first protrusion that protrudes relative to an inner wall of the first area and an inner wall of the second area, and the second variable-diameter portion is a second protrusion that protrudes relative to an inner wall of the third area, so that metal vapor generated by separation of the movable contact and the stationary contact can be limited in the space defined by the first area.

2. The vacuum interrupter according to claim 1, wherein a transverse limited dimension of the first area is smaller than a transverse limited dimension of the third area, and the second protrusion is a step portion at a boundary of the first area and the third area.

3. The vacuum interrupter according to claim 2, wherein the transverse limited dimension of the first area is at least 5% smaller than the transverse limited dimension of the third area.

4. The vacuum interrupter according to claim 3, wherein the transverse limited dimension of the first area is 5% to 20% smaller than the transverse limited dimension of the third area.

5. The vacuum interrupter according to claim 1, wherein outer surfaces of the first area, the second area, and the third area are flush with each other, the first area has a first thickness, and the third area has a thickness less than the first thickness.

6. The vacuum interrupter according to claim 5, wherein the thickness of the third area is 80% to 95% of the first thickness.

7. The vacuum interrupter according to claim 5, wherein the second area has a thickness less than the first thickness.

8. The vacuum interrupter according to claim 5, wherein the outer surfaces of the first area, the second area, and the third area further have a corrugated structure.

9. The vacuum interrupter according to claim 1, wherein the movable contact and the stationary contact each comprise a first portion and a second portion protruding from the first portion, a transverse dimension of the first portion being greater than a transverse dimension of the second portion.

10. The vacuum interrupter according to claim 9, wherein the transverse dimension of the first portion is at least 10% greater than the transverse dimension of the second portion.

11. The vacuum interrupter according to claim 10, wherein the transverse dimension of the first portion is 10% to 20% greater than the transverse dimension of the second portion.

12. The vacuum interrupter according to claim 1, wherein the movable contact assembly further comprises a movable conductive rod, the stationary contact assembly further comprises a stationary conductive rod, the movable conductive rod and the movable contact each have a matching mechanical connection portion, and the stationary conductive rod and the stationary contact each have a matching mechanical connection portion.

13. The vacuum interrupter according to claim 12, wherein at least one of the movable conductive rod and the stationary conductive rod is a stainless steel conductive rod.

14. The vacuum interrupter according to claim 13, wherein a diameter of the stainless steel conductive rod is less than 15 mm.

15. The vacuum interrupter according to claim 13, wherein a diameter of the insulating housing is less than 80 mm.

16. A vacuum switch, comprising the vacuum interrupter according to claim 1.

17. A vacuum switch, comprising the vacuum interrupter according to claim 2.

18. A vacuum switch, comprising the vacuum interrupter according to claim 5.

19. A parallel load switch, comprising the vacuum switch according to claim 16 and a rotary switch, wherein the rotary switch comprises a first wiring terminal, a second wiring terminal, a rotary driving conductive rod, and an arc-shaped contact, the rotary driving conductive rod being configured such that one end thereof is electrically connected to the arc-shaped contact and to enable the arc-shaped contact to move along an arc, and the first wiring terminal and the second wiring terminal being arranged on the arc, wherein a first outgoing terminal of the vacuum switch is electrically connected to the first wiring terminal, a second outgoing terminal of the vacuum switch is electrically connected to a first terminal of the parallel load switch, the second wiring terminal is electrically connected to a second terminal of the parallel load switch, and the other end of the rotary driving conductive rod is electrically connected to a third terminal of the parallel load switch.

20. A parallel load switch, comprising the vacuum switch according to claim 17 and a rotary switch, wherein the rotary switch comprises a first wiring terminal, a second wiring terminal, a rotary driving conductive rod, and an arc-shaped contact, the rotary driving conductive rod being configured such that one end thereof is electrically connected to the arc-shaped contact and to enable the arc-shaped contact to move along an arc, and the first wiring terminal and the second wiring terminal being arranged on the arc, wherein a first outgoing terminal of the vacuum switch is electrically connected to the first wiring terminal, a second outgoing terminal of the vacuum switch is electrically connected to a first terminal of the parallel load switch, the second wiring terminal is electrically connected to a second terminal of the parallel load switch, and the other end of the rotary driving conductive rod is electrically connected to a third terminal of the parallel load switch.
